(19) United States
(12) Patent Application Publication
(10) Pub. No.: US 2019/0380369 A1
(43) Pub. Date: Dec. 19, 2019

(54) SOY SAUCE COMPOSITION

(71) Applicant: NUTRICARE S/A, Sao Paulo (BR)

(72) Inventors: Roger Takeo Maruyama, Marilia (BR); Rodrigo Martins De Souza, Sao Paulo (BR)

(73) Assignee: NUTRICARE S/A, Sao Paulo (BR)

(21) Appl. No.: 16/441,933

(22) Filed: Jun. 14, 2019

(30) Foreign Application Priority Data
Jun. 14, 2018 (BR) 10 2018 012036

(51) Int. Cl. A23L 27/50

(52) U.S. Cl. CPC A23L 27/50

(57) ABSTRACT

A sodium-free soy sauce having a taste similar to traditional soy sauce that has potassium chloride (KC1), glutamic acid, soybean, caramel coloring, and corn or wheat.

### FIELD OF THE APPLICATION

The present application relates to a soy sauce and its production process. More specifically, the present invention relates to a significant decrease in the amount of sodium in its composition.

### BACKGROUND OF THE INVENTION

The soy sauce, commonly known as “shoyu” sauce is a typically Japanese seasoning that has a unique flavor. This seasoning is known and used worldwide in many different cuisines.

This seasoning is traditionally produced in a well-defined and commonly known stages, which are: 1) Koji production; 2) Moromi production; 3) obtaining the soybean sauce extract; 4) addition of seasonings; 5) baking the mixture; and 6) let the product rest.

However, since common soy sauce has a large amount of salt, it is known that excessive intake of this ingredient affects the kidneys, heart, among other organs and can cause various diseases.

Therefore, in order to avoid diseases arising from the ingestion of high NaCl concentrations, products found in the state of the art, which describe soy sauces containing potassium chloride to decrease the salt content, are commonly found, but always associated with the presence of sodium chloride in its composition.

A soy sauce containing KCl is always associated with NaCl, since KCl has a bitter taste characteristic, thus, to reduce/mask this unpleasant taste, various additives are added, among them calcium chloride and/or magnesium chloride (JPS58209957); nucleic acid and/or amino acid seasoning (JPS5955165); basic amino acid and/or a basic peptide (WO2006114918); glutamic acid or aspartic acid (JPWO2011040505), among others. However, a document describing a soy sauce containing only KCl without addition of NaCl is not found in the prior art.

The JPH0235056 document relates to a synthetic soy sauce and its method of production. This document describes a synthetic soy sauce without using any salt, whereas water and potassium chloride are mixed. This solution is heated and potassium alum, etc., and yeast extract are added and further mixing a sweetener and a thickening agent.

The WO2006033205 document relates to soy sauce with a low salt content. This feature is obtained by the addition of 1.0 to 10.0 wt % of potassium chloride and 0.1 to 5.0 wt % of aminobutyric acid. The low salt soy sauce containing KCl is obtained by a method in which the removal of the common salt is performed by electrodialysis, membrane treatment, etc. from a soy sauce obtained using a common salt solution as feed water or other method and adding aminobutyric acid to the low salt soya sauce containing KCl.

The JP2007181450 document relates to a salt-free seasoning liquid similar to soy sauce which contains neither sodium chloride nor potassium chloride. It is a salt-free seasoning liquid similar to the soy sauce prepared to have optionally about 0.001 to 18% of salt content, whereas said seasoning liquid is not produced by conventional production methods. The seasoning liquid of this invention is obtained by maturation of Moromi soaked in alcohol at 20° C., in order to produce a feedstock from the seasoning liquid, which is heated and condensed to remove alcohol and add a saccharide and an amino acid thereto. The seasoning liquid, which is similar to soy sauce prepared to have an optional salt concentration of 0.001 to 18%, is obtained by the addition of an optional amount of soy sauce and salt to the salt-free seasoning liquid similar to soy sauce.

### OBJECTS OF THE INVENTION

Although there are temperature and preparation time variations and different uses of ingredients, the soy sauces commonly found, in their great majority, present expressive amounts of sodium in their final composition. There are levels above >600 mg of sodium for every 10 ml of soy sauce in traditional products, and above >300 mg of sodium for every 10 ml of soy sauce for those that has some appeal of sodium reduction.

The state of the art documents have a certain effect on the salt reduction when compared to the traditional product, but it can not be assured that these products have a really low salt content, so it is not advisable to ingest this kind of product continuously. The available techniques are insufficient in terms of compatibility between reduction of salt concentration and maintenance of the unique soy sauce taste. Therefore, as the state of the art has not solved the problem of soy sauce totally free of NaCl, the present patent application intends to promote a truthfully sodium-free product.

### BRIEF DESCRIPTION OF THE INVENTION

The soya sauce of the present invention has in its composition the potassium chloride instead of sodium chloride. The substitution is made in the proportion of 1 part of potassium chloride in place of 1 part of the sodium chloride. Therefore, the soy sauce of the present invention retains the traditional soy sauce flavor characteristics, even free of sodium.

### DETAILED DESCRIPTION OF THE INVENTION

It is an object of the present invention to provide a sodium-free soy sauce having a similar flavor to traditional soy sauce. Therefore, the intent of reducing the sodium presence in the formulation consists of not using sodium in the brine and, at the same time, being able to interrupt the fermentation process.

Therefore, the present invention has focused on the replacement of NaCl by KCl in its composition. For this purpose, the substitution is made in the proportion of 1 part KCl instead of 1 part KCl of the formulation.

It is known that the presence of sodium in the soy sauce occurs as a function of its addition in the brine step and in any of the subsequent production steps, but mainly at the fermentation termination step. In the process of the present invention, the KCl has developed the same paper, stopping the fermentation. The amount of KCl added to the composition is in the range of 8.0% to 12.0 wt %, preferably 10.0 wt %.

However, it is known that KCl provides a bitter taste characteristic. To mask this undesirable flavor, high purity glutamic acid in the proportion of 0.03% to 0.05 wt %, preferably 0.04% was added to the soy sauce.

### Preferred Embodiment of the Invention

We present below 3 compositions, by way of example and not limiting way, that make up the scope of the invention.

### EXAMPLE 1

| Component | WT % |
|---|---|
| Soybean Extract | 48 |
| Corn/Wheat | 20 |
| Caramel coloring | 1.6 |
| Potassium Chloride | 8 |
| Glutamic Acid | 0.032 |
| Water (q.s.) | 22.37 |

### EXAMPLE 2

| Component | WT % |
|---|---|
| Soybean Extract | 60 |
| Corn/Wheat | 25 |
| Caramel coloring | 2 |
| Potassium Chloride | 10 |
| Glutamic Acid | 0.04 |
| Water (q.s.) | 2.96 |

### EXAMPLE 3

| Component | WT % |
|---|---|
| Soybean Extract | 60.5 |
| Corn/Wheat | 25 |
| Caramel coloring | 2.4 |
| Potassium Chloride | 12 |
| Glutamic Acid | 0.05 |
| Water | — |

It may be seen that the soy sauce of the present invention has a concentration of soybean extract in the range of 48% to 60%, preferably 60%, while other soy sauces has a concentration about 20 to 50% soybean extract.

To prove the taste quality of the present invention product, a sensory test was performed with 2 types of soy sauces used worldwide: traditional and light, whereas the salt reduction (NaCl) in the light product compared to the traditional one is 40%, i.e. from 27 wt % to 16 wt % of NaCl. This test was performed in order to check the taste in relation to the presence of salt compared to the salt-free soy sauce of the present invention.

For this purpose, the following method was used to evaluate the taste quality in relation to the presence of salt:

“−”: mild salty taste;

“+”: moderate salty taste; and

“++”: strong salty taste.

The results are shown in Table 1 below.

TABLE 1
Sensory test to verify the taste in relation to the presence of salt
TABLE 2

| | | | Sensory | |
|---|---|---|---|---|
| | | | test | |
| | | | results | |
| | | | (presence | |
| | | | or absence | |
| Item | Salt Quantity | | of | |
| Control | NaCl | KCl | bitter taste) | Observations |
| Comparative | 649 mg/ | 0 mg/10 ml | ++ | Strong salty taste |
| Example | 10 ml | | | due to the presence |
| 1 | | | | of salt and alcohol. |
| | | | | Taste reference of |
| | | | | traditional soy sauce. |
| Comparative | 373 mg/ | 0 mg/10 ml | + | Strong salty taste |
| Example | 10 ml | | | but less intense |
| 2 | | | | when compared to |
| | | | | example 1. Taste |
| | | | | reference of light |
| | | | | soy sauce. |
| Present | 0 mg/ | 263 mg/10 | − | Excellent soy taste, |
| invention | 10 ml | ml | | with a mild salty |
| | | | | taste when compared |
| | | | | to traditional |
| | | | | sauce. |

According to the results of the sensory test of table 1, it was proved that the absence of salt did not affect the flavor of the product. In addition, the bitter taste of KCl in the soy sauce of the present invention was significantly reduced as a function of the addition of glutamic acid. Therefore, it is concluded that the present invention is advantageous as a product actually being “zero sodium” compared to traditional and low salt soy sauces.

1. A soy sauce, the composition being free of sodium (NaCl).

2. The soy sauce according to claim 1, wherein said composition further comprises potassium chloride (KCl), glutamic acid, soybean, caramel coloring, and corn or wheat.

3. The soy sauce composition according to claim 1, wherein the composition comprises a range of 8 wt % to 12 wt % of potassium chloride; 0.03 wt % to 0.05 wt % of glutamic acid, 48 wt % to 60.5 wt % of soybean extract, 20 wt % to 25 wt % of corn or wheat, 1.6 wt % to 2.4 wt % of dye caramel and water q.s.

4. The soy sauce composition according to claim 3, wherein the composition comprises 10 wt % of potassium chloride; 0.04 wt % of glutamic acid, 60% of soybean extract, 25 wt % of corn or wheat, 2 wt % of caramel dye and water q.s.

5. (canceled)
